(19) United States
(12) Patent Application Publication
(10) Pub. No.: US 2018/0247735 A1
(43) Pub. Date: Aug. 30, 2018

(54) Reflective protective sheath for a cable

(71) Applicant: NEXANS, Courbevoie (FR)

(72) Inventors: Bernard DALBE, LYON (FR); Aurélie PERRAS, TOUSSIEUX (FR); Matthias MEYER, Luebeck (DE); Birane TOURE, Villeurbanne (FR); Sarah LE DREN, Ermont (FR); Daniel HALLER, Lauf (DE); Encarnacion GONZALEZ CALVO, Schwabach (DE)

(21) Appl. No.: 15/753,383

(22) PCT Filed: Jul. 22, 2016
(86) PCT No.: PCT/FR2016/051910

§ 371 Date: Feb. 19, 2018

(30) Foreign Application Priority Data
Aug. 21, 2015 (FR) 1557852

(51) Int. Cl. H01B 7/18; H01B 3/30; H01B 3/42; H01B 13/14; G02B 5/136

(52) U.S. Cl. CPC H01B 7/187; H01B 3/302; H01B 7/361; H01B 13/148; G02B 5/136; H01B 3/427

(57) ABSTRACT

The present invention relates to a cable (1) comprising one or more elongated conductive elements (11), said elongated conductive element or the set of said elongated conductive elements (11) being surrounded by a protective sheath (20), characterized in that the outer surface and/or the inner surface of the protective sheath comprises at least one longitudinal groove (21) in which is positioned at least one reflective longitudinal element (30) obtained from a first composition comprising a first polymer material and at least one reflective filler.

The present invention relates to a cable comprising at least one elongated conductive element surrounded by a reflective protective sheath.

It applies typically, but not exclusively, to the fields of mining cables, which are mainly used in dark environments and subjected to high mechanical stresses.

Reflective cables are well known to a person skilled in the art. Mention may be made, by way of example, of document WO 2007/054457 which describes a retroreflective electric cable comprising beads positioned between a first polymer layer and a second polymer layer.

That being so, this reflective cable is in no way suitable for the mining field, in which field the cable is subjected to numerous mechanical stresses. Moreover, the manufacturing process is not optimal since it requires numerous manufacturing steps.

The objective of the present invention is to overcome the drawbacks of the techniques of the prior art by proposing a cable comprising at least one reflective protective sheath having very good mechanical properties, while guaranteeing very good optical reflection properties throughout the lifetime of the cable.

One subject of the present invention is a cable comprising one or more elongated conductive elements, said elongated conductive element or the set of said elongated conductive elements being surrounded by a protective sheath, characterized in that the outer surface and/or the inner surface of the protective sheath comprises at least one longitudinal groove in which is positioned a reflective longitudinal element obtained from a first composition comprising a first polymer material and at least one reflective filler.

The invention advantageously presents a cable comprising a protective sheath having a high mechanical strength while being easily visible by optical reflection throughout the lifetime of the cable.

In the present invention, an “outer surface” of the protective sheath is understood to mean the surface of the protective sheath furthest from the elongated conductive element(s) that it surrounds (in the cross section of the cable).

An “inner surface” of the protective sheath is understood to mean the surface of the protective sheath nearest the elongated conductive element(s) that it surrounds (in the cross section of the cable).

The Reflective Longitudinal Element

In the present invention, the reflective longitudinal element, owing to the reflective filler contained in the first composition, makes it possible to reflect incident light, originating for example from a light source such as a torch or motor vehicle headlight, in order to make the cable of the invention visible in a dark environment.

The outer surface and/or the inner surface of the protective sheath comprises one or more reflective longitudinal elements. It may be referred to as a reflective protective sheath.

The reflective longitudinal element is preferably continuous along the cable. The reflective longitudinal element may extend helically along the cable.

It at least partly, preferably completely, fills the depth of at least one longitudinal groove of the protective sheath, in which it is positioned.

The reflective element, obtained from a first composition comprising a first polymer material and at least one reflective filler, may be crosslinked or non-crosslinked.

The crosslinking may be carried out by techniques well known to a person skilled in the art, such as for example by peroxide crosslinking under the action of heat. In this case, the first composition may further comprise an organic peroxide.

In the context of the invention, a “crosslinked element” is understood to mean an element that satisfies the “Hot set test” according to the standard IEC 60811-507 with a hot creep under load (elongation as percentage) of at most 175%. In other words, the first polymer material that constitutes the reflective element is a crosslinked material.

A “non-crosslinked element” is understood to mean an element that does not meet the standard IEC 60811-507.

The first polymer material may comprise at least one polymer A having a glass transition temperature (Tg) of at most 10° C., preferably of at most 0° C., preferably of at most −10° C. and preferably of at most −20° C.

In the present invention, the glass transition temperature of a polymer may be conventionally measured by differential scanning calorimetry (DSC) with a temperature ramp of 10° C./min under a nitrogen atmosphere.

The polymer A may have a Young's modulus of at most 200 MPa, preferably of at most 100 MPa, and particularly preferably of at most 60 MPa.

In the present invention, the Young's modulus is typically determined using a tensile testing machine comprising a force sensor. During the stretching of the sample of material, the force sensor transmits a signal proportional to the force imposed on the sample.

In the case of solid polymers, it is rare for Hooke's law to be valid over the entire elongation range until the specimen breaks. For this reason, it is customary to define the Young's modulus of polymers by considering the limiting behaviour at low elongations.

The Young's modulus is then calculated from the initial slope of the curves σ=f(ε) with

$$E = {lim}_{ɛ \to 0} \frac{d {σ}_{true}}{d ɛ} .$$

The polymer A may have an abrasion resistance of at most 250 mg.

In the present invention, the abrasion resistance may be performed according to the TABER abrasion test with a Taber 5700 linear abraser with the following conditions: 25 cycles/min; 1000 cycles; load of 1.1 kg; and 7.62 cm abrasion length.

The first polymer material may preferably be a transparent or translucent polymer material, in order to be able to improve the viewing of the reflective filler within the first polymer material.

In the present invention, “transparent” is understood to mean an element or a polymer material that allows the luminous flux to pass through to a greater or lesser extent and through which objects are clearly visible. More particularly, it is an element or a polymer material through which an image is observed without significant loss of contrast: the insertion of said transparent element or of said transparent polymer material between an image and an observer thereof does not significantly reduce the quality of the image.

In the present invention, “translucent” is understood to mean an element or a polymer material that transmits light diffusely and through which objects appear blurry.

Said polymer A may be chosen from one or more of the following polymers: polychloroprene, chlorinated polyethylene (CPE), ethylene propylene diene monomer elastomer, ethylene propylene elastomer, chlorosulfonated polyethylene elastomer, butadiene/acrylonitrile copolymer, hydrogenated butadiene/acrylonitrile copolymer, acrylonitrile elastomer, natural rubber, fluorocarbon elastomer, butadiene elastomer, butyl elastomer, chlorobutyl elastomer, bromobutyl elastomer, styrene/butadiene copolymer, silicone elastomer, polypropylene, polyethylene, ethylene/vinyl acetate copolymer, ethylene/butyl acrylate copolymer, thermoplastic polyolefin elastomer (TPO), thermoplastic vulcanized elastomer (TPV), thermoplastic polyurethane elastomer (TPU), thermoplastic polyamide elastomer (TPA), thermoplastic polystyrene elastomer (TPS), thermoplastic copolyester elastomer (TPC).

The polymer A preferably used in the invention may be chosen from a thermoplastic polyurethane elastomer (TPU), a chlorinated polyethylene (CPE), and a mixture thereof.

More particularly, the chlorinated polyethylene may comprise at least 20% by weight of chlorine, and preferably between 30% and 40% by weight of chlorine.

The first composition may comprise more than 50% by weight of polymer(s) A, preferably more than 70% by weight of polymer(s) A, and particularly preferably more than 90% by weight of polymer(s) A, relative to the total weight of polymer material. Preferably, the first polymer material is solely composed of one or more polymers A.

The first composition may comprise at least 30% by weight of first polymer material, preferably at least 40% by weight of first polymer material, and particularly preferably at least 50% by weight of first polymer material, relative to the total weight of the first composition.

The reflective filler included in the first composition advantageously makes it possible to reflect incident light in the whole of the thickness of the reflective longitudinal element. Thus, even if the protective sheath of the cable is subjected to surface abrasion in operational configuration, the light reflection properties of the cable remain intact.

The reflective filler may be chosen from metal particles, metallized particles, inorganic particles with a refractive index of greater than or equal to 1.5, and a mixture thereof.

The metal particles may be chosen from particles made of aluminium, of aluminium alloy, of silver and of silver alloy.

The metallized particles may be particles composed of a support covered by a metal coating or by a metal alloy coating.

By way of example, the support may be a polymer such as a polyester. The metal or metal alloy coating may be chosen from a coating made of aluminium, of aluminium alloy, of silver and of silver alloy.

The metal or metallized particles may have a shape factor of strictly greater than 1, preferably of at least 10, preferably of at least 20, particularly preferably of at least 100. Said filler is preferably of lamellar type.

In the present invention, the shape factor is typically the ratio between the smallest dimension of the particle (such as for example the thickness of the particle for a lamellar-shape particle) and the largest dimension of said particle (such as for example the length of the particle for a lamellar-shape particle).

The inorganic particles may have a refractive index of at least 1.5, and preferably of at least 1.8.

By way of example, the inorganic particles used as reflective filler may be based on silicon dioxide, and more particularly glass beads. The glass may also advantageously contain other oxides such as boron, barium, calcium and/or titanium oxides.

The shape factor of these inorganic particles may preferentially be equal to 1, or in other words these particles are of substantially spherical shape.

In one particular embodiment, the reflective filler of the invention is a micrometric filler.

Micrometric fillers typically have at least one of their dimensions of micrometre size (10⁻⁶ metre).

The term “dimension” is understood to mean the number-average dimension of all of the micrometric fillers of a given population, this dimension conventionally being determined by methods well known to a person skilled in the art.

The dimension of the micrometric fillers according to the invention may for example be determined by microscopy, in particular by a transmission electron microscope (TEM).

The number-average dimension of the micrometric fillers (i.e. at least one of their dimensions) may in particular be at most 800 μm, preferably at most 600 μm, and more preferentially at most 400 μm.

In one particular embodiment, the number-average dimension of the micrometric fillers (i.e. at least one of their dimensions) is at least 1 μm and at most 100 μm, preferably at least 1 μm and at most 60 μm, and particularly preferably at least 5 μm and at most 30 μm.

When said metal or metallized particles are used as reflective filler in the first composition, the number-average dimension of these fillers (i.e. at least one of their dimensions) may be at most 400 μm, and preferably may range from 1 to 100 μm.

When said inorganic particles are used as reflective filler in the first composition, the number-average dimension of these fillers (i.e. at least one of their dimensions) may range from 10 to 300 μm, and preferably range from 30 to 80 μm.

The first composition of the invention may comprise a sufficient amount of reflective filler(s) to be able to obtain the desired properties.

By way of example, the first composition may comprise from 0.1 to 100 parts by weight of reflective filler(s), and preferably from 1 to 90 parts by weight of reflective filler(s), per 100 parts by weight of the first polymer material in the first composition.

When said metal or metallized particles are used as reflective filler in the first composition, the first composition may comprise from 0.1 to 30 parts by weight of said metal or metallized particles, and preferably from 1 to 20 parts by weight of said metal or metallized particles, per 100 parts by weight of the first polymer material in the first composition.

When said inorganic particles are used as reflective filler in the first composition, the first composition may comprise from 20 to 90 parts by weight of said inorganic particles, and preferably from 40 to 60 parts by weight of said inorganic particles, per 100 parts by weight of the first polymer material in the first composition.

In one particular embodiment of the invention, the first composition of the invention may further comprise an additive D, different from the reflective filler, said additive D in particular being intended to improve the optical reflection of the reflective filler in the reflective element.

Preferably, when the first composition comprises said inorganic particles (with a refractive index greater than or equal to 1.5) as reflective filler, the first composition may further advantageously comprise said additive D.

The additive D is preferably of micrometre size, or in other words has at least one of its dimensions of micrometre size (10⁻⁶ metre).

The number-average dimension of said additive D (i.e. at least one of its dimensions) may be at least 1 μm and at most 100 μm, preferably at least 1 μm and at most 50 μm, and particularly preferably at least 5 μm and at most 20 μm.

The shape factor of this type of additive D may be greater than or equal to 1.

The additive D may preferably be chosen from metal particles, particles derived from a metal, and a mixture thereof.

The metal particles may for example be particles made of aluminium, of aluminium alloy, of silver and of silver alloy.

The particles derived from a metal may for example be metal oxide particles, such as in particular titanium dioxide particles. The micrometric metal oxide particles may in particular be pigments.

The first composition of the invention may comprise a sufficient amount of additive D to be able to obtain the desired properties.

By way of example, the first composition may comprise from 0.01 to 10 parts by weight of additive D, and preferably from 0.01 to 5 parts by weight of additive D, per 100 parts by weight of the first polymer material in the first composition.

The additive D may be incorporated into the first composition as is, or else in the form of a masterbatch to facilitate its incorporation and its distribution within the polymer matrix. The base of this masterbatch may be a polymer, or a mineral oil such as for example a mixture of saturated hydrocarbons.

In the present invention, the first composition may advantageously be extruded along the cable, by techniques well known to a person skilled in the art.

The Protective Sheath and the Longitudinal Groove(s)

The protective sheath extends longitudinally along the cable and surrounds the single elongated conductive element or the set of elongated conductive elements.

Preferably, the protective sheath is the outermost layer of the cable. It comprises on its outer surface and/or on its inner surface one or more longitudinal grooves along the cable, positioned in the thickness of the protective sheath.

More particularly, the protective sheath may comprise:
one or more longitudinal grooves on its outer surface, or
one or more longitudinal grooves on its inner surface, or
one or more longitudinal grooves on its outer surface and one or more longitudinal grooves on its inner surface.

Each groove may advantageously be of identical shape.

According to one embodiment, the longitudinal groove may be obtained from a notch of “V”-shaped (i.e. triangular) or “U”-shaped (rectangular) cross section, the centre line of which is preferably radial on the cable. Preferably, each of the longitudinal grooves is obtained from a notch of “V”-shaped (i.e. triangular) or “U”-shaped (rectangular) cross section, the centre line of which is preferably radial on the cable.

Said groove may extend parallel to the longitudinal axis of the cable or helically along the cable.

The depth of the groove preferably does not exceed three quarters of the maximum thickness of the protective sheath.

The groove may advantageously have a depth of at least ⅛, preferably of at least ⅙, and particularly preferably of at least ¼, relative to the maximum thickness of the protective sheath.

When the protective sheath comprises at least two longitudinal grooves on the same surface, each longitudinal groove is placed equidistant from one another. Moreover, the longitudinal grooves may be parallel to one another.

In the present invention, the expression “on the same surface” means the outer surface of the protective sheath or the inner surface of the protective sheath.

The longitudinal groove(s), positioned on the outer surface and/or on the inner surface of the protective sheath and in the thickness of the protective sheath, may be easily manufactured using a suitable extrusion head at the die outlet of an extruder.

More particularly, the longitudinal groove(s), positioned on the outer surface and/or on the inner surface of the protective sheath and in the thickness of the protective sheath, may be easily generated in the protective sheath material, with the aid of a die, one or more punches and a suitable extrusion head.

The protective sheath is preferably a polymer sheath.

According to a first embodiment, the protective sheath is neither a transparent nor translucent sheath. It is preferably coloured. This first embodiment applies in particular when the inner surface of the protective sheath comprises no longitudinal groove in which said reflective longitudinal element is positioned.

According to a second embodiment, the protective sheath is a transparent or translucent sheath. It is preferably not coloured. This second embodiment applies in particular when the inner surface of the protective sheath comprises at least one longitudinal groove in which said reflective longitudinal element is positioned. This second embodiment enables the reflective element positioned in the longitudinal groove on the inner surface of the protective sheath to be visible on the outside of the protective sheath.

It may be obtained from a second composition comprising a second polymer material, and optionally fillers and/or additives well known to a person skilled in the art. By way of example, mention may be made, as fillers, of inert fillers such as kaolin, chalk; and as additive, of processing aids, protective agents, plasticizers, co-crosslinking agents, crosslinking agents such as organic peroxides.

The protective sheath may be crosslinked or non-crosslinked.

The crosslinking may be carried out by techniques well known to a person skilled in the art, such as for example by peroxide crosslinking under the action of heat. In this case, the second composition may further comprise an organic peroxide.

In the context of the invention, a “crosslinked sheath” is understood to mean a sheath that satisfies the “Hot set test” according to the standard IEC 60811-507 with a hot creep under load (elongation as percentage) of at most 175%. In other words, the second polymer material that constitutes the protective sheath is a crosslinked material.

A “non-crosslinked sheath” is understood to mean a sheath that does not meet the standard IEC 60811-507.

In one particular embodiment, the protective sheath is an electrically insulating sheath.

In the present invention, “electrically insulating” is understood to mean a layer or a sheath having an electrical conductivity that may be at most 1×10⁻⁹ S/m (siemens per metre) (at 25° C.), and preferably at most 1×10⁻¹² S/m (at 25° C.).

The second polymer material may be identical to or different from the first polymer material.

According to a first embodiment, the second polymer material is neither a transparent nor translucent material. It may advantageously be coloured. This first embodiment applies in particular when the inner surface of the protective sheath comprises no longitudinal groove in which said reflective longitudinal element is positioned.

According to a second embodiment, the second polymer material is a transparent or translucent material. It is preferably not coloured. This second embodiment applies in particular when the inner surface of the protective sheath comprises at least one longitudinal groove in which said reflective longitudinal element is positioned.

The second polymer may comprise at least one polymer B having a glass transition temperature (Tg) preferably of at most 0° C., preferably of at most −10° C., and preferably of at most −20° C.

The polymer B may have a Young's modulus of at most 200 MPa, preferably of at most 100 MPa, and particularly preferably of at most 60 MPa.

The polymer B may have an abrasion resistance of at most 250 mg.

Said polymer B may be chosen from one or more of the following polymers: polychloroprene, chlorinated polyethylene (CPE), ethylene propylene diene monomer elastomer, ethylene propylene elastomer, chlorosulfonated polyethylene elastomer, butadiene/acrylonitrile copolymer, hydrogenated butadiene/acrylonitrile copolymer, acrylonitrile elastomer, natural rubber, fluorocarbon elastomer, butadiene elastomer, butyl elastomer, chlorobutyl elastomer, bromobutyl elastomer, styrene/butadiene copolymer, silicone elastomer, polypropylene, polyethylene, ethylene/vinyl acetate copolymer, ethylene/butyl acrylate copolymer, thermoplastic polyolefin elastomer (TPO), thermoplastic vulcanized elastomer (TPV), thermoplastic polyurethane elastomer (TPU), thermoplastic polyamide elastomer (TPA), thermoplastic polystyrene elastomer (TPS), thermoplastic copolyester elastomer (TPC).

The polymer B preferably used in the invention may be chosen from a thermoplastic polyurethane elastomer (TPU), a chlorinated polyethylene (CPE), and a mixture thereof.

More particularly, the second composition may comprise more than 50% by weight of polymer(s) B, preferably more than 70% by weight of polymer(s) B, and particularly preferably more than 90% by weight of polymer(s) B, relative to the total weight of polymer material. Preferably, the first polymer material is solely composed of one or more polymers B.

In one particular embodiment, the second composition may comprise at least 30% by weight of second polymer material, preferably at least 50% by weight of second polymer material, and particularly preferably at least 70% by weight of second polymer material, relative to the total weight of the second composition.

In the present invention, the second composition may advantageously be extruded along the cable, by techniques well known to a person skilled in the art.

The protective sheath of the invention may be a sheath of tubing type or of filling type.

A “tubing sheath” is understood to mean a tube-shaped sheath comprising a substantially identical thickness all along said tube. The tubing sheath may be more or less tight around the set of insulated conductors so as, in particular, to immobilize the set of said insulated conductors inside said sheath.

The tubing sheath is very simple and rapid to produce since it requires a pressure at the outlet of the extruder that is lower than that necessary for the manufacture of a filling sheath.

A “filling sheath” is understood to mean a sheath that fills the interstices between the insulated electrical conductors, the volumes of which are accessible.

The Cable

The cable of the invention may be an electric and/or optical cable, intended for energy transport and/or data transmission.

More particularly, this type of cable comprises one or more elongated conductive elements of electric and/or optical type.

The set of elongated conductive elements forming the cable extends inside the protective sheath.

In one particularly preferred embodiment, the cable of the invention may comprise one or more insulated elongated electrical conductors, and optionally one or more non-insulated elongated electrical conductors.

The insulated electrical conductor(s) may conventionally be elongated conductors respectively surrounded by at least one electrically insulating layer.

The elongated electrical conductor may be a single-part conductor such as for example a metal wire, or a multi-part conductor such as a plurality of metal wires, which are optionally twisted.

The elongated electrical conductor may be produced from a metal material in particular chosen from aluminium, an aluminium alloy, copper, a copper alloy, and a combination thereof.

The cable of the invention may have an external diameter ranging from 20 to 90 mm. Moreover, the protective sheath of the cable of the invention may have a thickness ranging from 1 to 10 mm, and preferably ranging from 2 to 8 mm.

Cable Manufacturing Process

The cable of the present invention may advantageously be obtained by co-extruding the protective sheath together with the reflective longitudinal element.

In other words, the first composition and the second composition of the invention may be extruded by means of a suitable extrusion head, and may thus be deposited at the same time around the elongated conductive element(s).

Moreover, the longitudinal groove(s), positioned on the outer surface and/or on the inner surface of the protective sheath and in the thickness thereof, may be easily generated in the protective sheath material, with the aid of a die, one or more punches and a suitable extrusion head.

It thus becomes very simple to manufacture the reflective protective sheath of the invention, by significantly minimizing the manufacturing steps.

Other features and advantages of the present invention will become apparent in light of the description of nonlimiting examples, and figures.

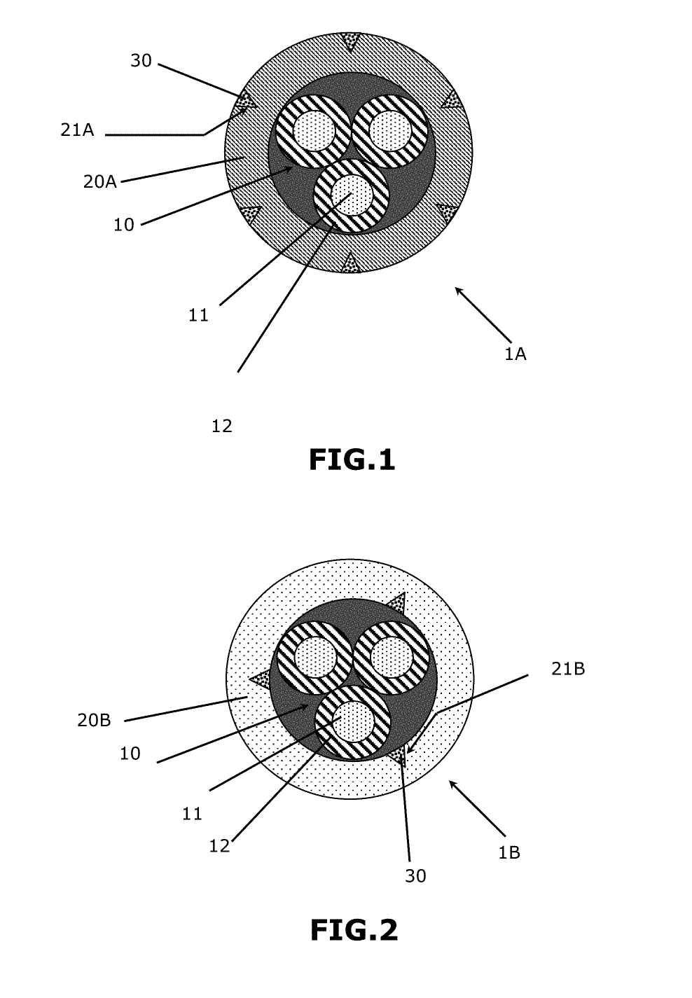

FIG. 1 represents a schematic cross-sectional view of a cable according to a first embodiment of the invention.

FIG. 2 represents a schematic cross-sectional view of a cable according to a second embodiment of the invention.

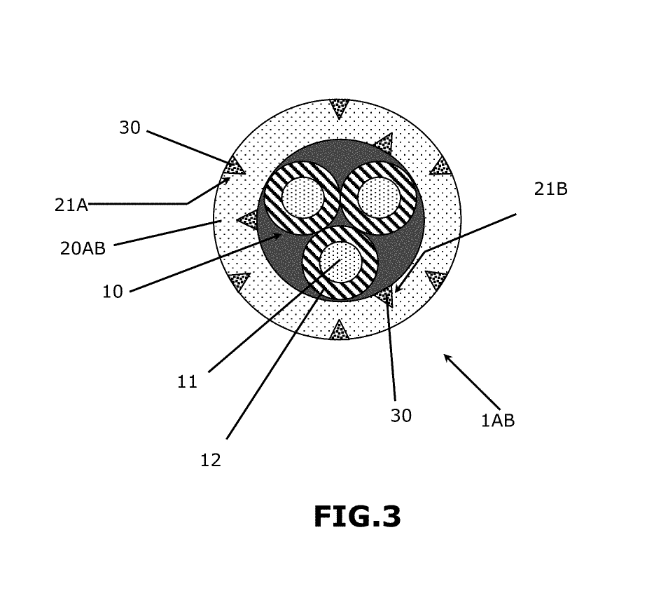

FIG. 3 represents a schematic cross-sectional view of a cable according to a third embodiment of the invention.

For reasons of clarity, only the elements essential to the understanding of the invention have been represented schematically, this not being done to scale.

FIG. 1 represents a cross-sectional view of an electric cable 1A according to a first embodiment in accordance with the invention. Said electric cable 1 comprises a set 10 of three insulated electrical conductors, each insulated electrical conductor comprising an electrical conductor 11 surrounded by an electrically insulating layer 12.

The set 10 of these three insulated electrical conductors is surrounded by a protective sheath 20A in accordance with the invention.

This protective sheath 20A comprises, on its outer surface, six “V”-shaped longitudinal grooves 21A in the thickness of said protective sheath.

These six grooves are positioned substantially equidistant from one another, and more particularly at around 60° from one another. Moreover, the inner surface of the protective sheath 20A comprises no longitudinal groove.

This grooved protective sheath 20A depicted in FIG. 1 is referred to as a tubing sheath. It is obtained by a continuous extrusion process, well known to a person skilled in the art. This protective sheath 20A is preferably a non-transparent and non-translucent sheath. It may be coloured.

Each of the six grooves is completely filled by a reflective longitudinal element 30 obtained for example from one of the compositions C1 to C6 as described in Table 1 below.

The sheath 20A and also the six reflective elements 30 are obtained by simultaneously extruding the composition of the protective sheath (i.e. second composition) and the composition of the reflective elements (i.e. first composition).

FIG. 2 represents a cross-sectional view of an electric cable 1B according to a second embodiment in accordance with the invention. Said electric cable 1B comprises a set 10 of three insulated electrical conductors, each insulated electrical conductor comprising an electrical conductor 11 surrounded by an electrically insulating layer 12.

The set 10 of these three insulated electrical conductors is surrounded by a protective sheath 20B in accordance with the invention.

This protective sheath 20B comprises, on its inner surface, three “V”-shaped longitudinal grooves 21B in the thickness of said protective sheath.

These three grooves are positioned substantially equidistant from one another, and more particularly at around 120° from one another. Moreover, the outer surface of the protective sheath 20B comprises no longitudinal groove.

This grooved protective sheath 20B depicted in FIG. 2 is referred to as a tubing sheath. It is obtained by a continuous extrusion process, well known to a person skilled in the art. This protective sheath 20B is preferably a transparent or translucent sheath.

Each of the three grooves is completely filled by a reflective longitudinal element 30 obtained for example from one of the compositions C1 to C6 as described in Table 1 below.

The sheath 20B and also the three reflective elements 30 are obtained by simultaneously extruding the composition of the protective sheath (i.e. second composition) and the composition of the reflective elements (i.e. first composition).

FIG. 3 represents a cross-sectional view of an electric cable 1AB according to a third embodiment in accordance with the invention. Said electric cable 1AB comprises a set 10 of three insulated electrical conductors, each insulated electrical conductor comprising an electrical conductor 11 surrounded by an electrically insulating layer 12.

The set 10 of these three insulated electrical conductors is surrounded by a protective sheath 20AB in accordance with the invention.

This protective sheath 20AB comprises, on its outer surface, six “V”-shaped longitudinal grooves 21A in the thickness of said protective sheath. These six grooves are positioned substantially equidistant from one another, and more particularly at around 60° from one another.

This protective sheath 20AB further comprises, on its inner surface, three “V”-shaped longitudinal grooves 21B in the thickness of said protective sheath. These three grooves are positioned substantially equidistant from one another, and more particularly at around 120° from one another.

This grooved protective sheath 20AB depicted in FIG. 3 is referred to as a tubing sheath. It is obtained by a continuous extrusion process, well known to a person skilled in the art. This protective sheath 20AB is preferably a transparent or translucent sheath.

Each of the grooves 21A and 21B, namely nine grooves in total, is completely filled by a reflective longitudinal element 30 obtained for example from one of the compositions C1 to C6 as described in Table 1 below.

The sheath 20AB and also the nine reflective elements 30 are obtained by simultaneously extruding the composition of the protective sheath (i.e. second composition) and the composition of the reflective elements (i.e. first composition).

Owing to the particular structure of the cables of the invention, the latter retain their reflective properties, even in environments subjected to high mechanical stresses, such as in mines.

### EXAMPLES

The abrasion properties of a reflective element according to the invention were tested.

Table 1 below assembles the compounds used to produce first compositions (C1 to C6) in accordance with the invention.

The amounts of the compounds are expressed in parts by weight per 100 parts by weight of polymer material (i.e. first polymer material) in the first composition.

The polymer material in Table 1 is composed either of a single chlorinated polyethylene (CPE), or of a single thermoplastic polyurethane elastomer (TPU).

TABLE 1

| First composition | C1 | C2 | C3 | C4 | C5 | C6 |
|---|---|---|---|---|---|---|
| CPE 1 | 100 | 0 | 100 | 0 | 0 | 0 |
| CPE 2 | 0 | 100 | 0 | 100 | 0 | 0 |
| TPU | 0 | 0 | 0 | 0 | 100 | 100 |
| Reflective filler 1 | 0 | 0 | 6 | 6 | 0 | 6 |
| Reflective filler 2 | 50 | 50 | 0 | 0 | 50 | 0 |
| Additive D | 0.1 | 0.1 | 0 | 0 | 0.1 | 0 |

The origin of the compounds from Table 1 is the following:
CPE 1 is a chlorinated polyethylene sold by BETAQUIMICA under the reference 1462 (Tg of CPE 1 equal to −25° C.);
CPE 2 is a chlorinated polyethylene sold by DOW under the reference TYRIN 3551 (Tg of CPE 2 equal to −25° C.);
TPU is a thermoplastic polyurethane elastomer sold by BASF under the reference TPU ELASTOLLAN 1185 A10 U (Tg of TPU equal to −42° C.);
Reflective filler 1 corresponds to metallized polyester glitter, with dimensions of 400 μm×400 μm×30 μm, sold by MINERAL COLOR under the reference Glitter.
Reflective filler 2 corresponds to glass beads with a diameter of 60 μm, sold by POTTERS under the reference Glass Microbeads;
Additive D corresponds to a paste containing aluminium particles (80% by weight of the paste) dispersed in a mineral oil (20% by weight of the paste), said particles being of micrometre dimensions (at least one of their dimensions is 15 μm), sold by ECKART under the reference Aluminium Paste STAPA WM Chromal V/80.

From the compositions of Table 1, films around 2-3 mm thick are manufactured by compression-moulding in order to perform the TABER abrasion test (with the Taber 5700 linear abraser) according to the following conditions:
25 cycles/min;
1000 cycles;
load: 1.1 kg;
abrasion length: 7.62 cm.

The compositions from Table 1 used for the abrasion test are not crosslinked compositions.

This abrasion test makes it possible to obtain a weight loss in milligrammes (mg).

The results of this test are assembled in Table 2 below:

TABLE 2

| Abrasion test (TABER) | C1 | C2 | C3 | C4 | C5 | C6 |
|---|---|---|---|---|---|---|
| Weight loss (mg) | 146 | 188 | 159 | 200 | 32 | 29 |

The weight losses generated by the abrasion remain relatively small, which guarantees good optical reflection properties throughout the lifetime of the cable.

1. Cable comprising:
one or more elongated conductive elements, said elongated conductive element or the set of said elongated conductive elements being surrounded by a protective sheath,
wherein the outer surface and/or the inner surface of the protective sheath comprises at least one longitudinal groove in which is positioned at least one reflective longitudinal element obtained from a first composition comprising a first polymer material and at least one reflective filler.

2. Cable according to claim 1, wherein the first polymer material comprises at least one polymer A having a glass transition temperature (Tg) of at most 10° C., and preferably of at most 0° C.

3. Cable according to claim 1, wherein the first polymer material comprises at least one polymer A chosen from a thermoplastic polyurethane elastomer (TPU), a chlorinated polyethylene (CPE), and a mixture thereof.

4. Cable according to claim 1, wherein the reflective filler is of micrometre size.

5. Cable according to claim 1, wherein the reflective filler is chosen from metal particles, metallized particles, inorganic particles with a refractive index of greater than or equal to 1.5, and a mixture thereof.

6. Cable according to claim 5, wherein the metal particles or the metallized particles have a shape factor of strictly greater than 1.

7. Cable according to claim 5, wherein the inorganic particles may be particles based on silicon dioxide.

8. Cable according to claim 7, wherein the particles based on silicon dioxide are glass beads.

9. Cable according to claim 1, wherein the first composition further comprises an additive D intended to improve the optical reflection of the reflective filler.

10. Cable according to claim 9, wherein the additive D is of micrometre size.

11. Cable according to claim 9, wherein the additive D is chosen from metal particles, particles derived from a metal, and a mixture thereof.

12. Cable according to claim 1, wherein the protective sheath is obtained from a second composition comprising a second polymer B having a glass transition temperature (Tg) of at most 10° C., and preferably of at most 0° C.

13. Cable according to claim 12, wherein the second polymer B is chosen from a thermoplastic polyurethane elastomer (TPU), a chlorinated polyethylene (CPE), and a mixture thereof.

14. Cable according to claim 1, wherein, when the inner surface of the protective sheath comprises at least one longitudinal groove in which said reflective longitudinal element is positioned, the protective sheath is a transparent or translucent sheath.

15. Cable according to claim 1, wherein the depth of the groove (21) does not exceed three quarters of the maximum thickness of the protective sheath.

16. Cable according to claim 1, wherein the protective sheath comprises at least two longitudinal grooves on the same surface, each longitudinal groove being placed equidistant from one another.

17. Cable according to claim 1, wherein the protective sheath comprises at least two longitudinal grooves on the same surface, each longitudinal groove being parallel to one another.

18. Process for manufacturing a cable according to claim 1, wherein the process comprises the step of: co-extruding the protective sheath together with the reflective longitudinal element.
